(19) United States
(12) Patent Application Publication
(10) Pub. No.: US 2025/0354902 A1
(43) Pub. Date: Nov. 20, 2025

(54) CUTTING DEVICE FOR BIOLOGICAL TISSUE SAMPLE

(71) Applicant: DR. FARSHID RAZAGHI INC., Mont-Royal (CA)

(72) Inventor: Farshid RAZAGHI, Mont-Royal (CA)

(21) Appl. No.: 18/664,995

(22) Filed: May 15, 2024

(51) Int. Cl. G01N 1/28

(52) U.S. Cl. CPC G01N 1/286; G01N 2001/2873

(57) ABSTRACT

A biological tissue cutting device for slicing a biological tissue sample, has: a base defining a cutting surface against which the biological tissue sample is laid on; a cutting assembly having a frame pivotably mounted to the base, the frame pivotable relative to the base about a pivot axis, and blades secured to the frame, the frame being movable from an open position in which the blades is distanced from the cutting surface to a closed position in which the blades contact the cutting surface.

### TECHNICAL FIELD

This disclosure generally relates to the field of medical devices and, more particularly, to medical devices in the field of pathology used to cut slices in tissue for subsequent analysis.

### BACKGROUND

Pathology is a very important corner stone of medicine and plays a crucial role in establishing the base for treating patients. The tissues received by pathologists go through several steps and eventually results in a glass slide with a thin cut of stained tissue. One of the most important initial steps is to cut the tissue, a step also referred to as grossing. The cutting step is used to provide the histology lab with an accurately cut tissue. Also, it is almost impossible to go back to a tissue and try to reconstruct it after cutting. Hence, precise cutting is of utmost importance. Improvements with systems and methods for cutting tissues is sought.

### SUMMARY

In one aspect, there is provided a biological tissue cutting device for slicing a biological tissue sample, comprising: a base defining a cutting surface against which the biological tissue sample is laid on; a cutting assembly having a frame pivotably mounted to the base, the frame pivotable relative to the base about a pivot axis, and blades secured to the frame, the frame being movable from an open position in which the blades is distanced from the cutting surface to a closed position in which the blades contact or are proximate to the cutting surface.

The biological tissue cutting device described above may include any of the following features, in any combinations.

In some embodiments, the blades are individually removable from the cutting assembly.

In some embodiments, the device includes means for individually adjusting tensions in the blades.

In some embodiments, the cutting surface extends continuously along a width and a depth of the base.

In some embodiments, the cutting surface is flat.

In some embodiments, the base includes a base plate and a cutting board removably secured to the base plate, the cutting surface defined by the cutting board.

In some embodiments, the cutting assembly is pivotably mounted to the base plate.

In some embodiments, the cutting surface has a rough surface finish.

In some embodiments, the frame includes two side supports extending transversally to the pivot axis and two blade holders extending transversally to the two side supports, ends of the blades mounted to the two blade holders.

In some embodiments, the ends of the blades are mounted to the two blade holders via a tensioning mechanism configured for varying tensions in the blades.

In some embodiments, the tensioning mechanism include blade trays, the blades secured to one or more of two blade holders via the blade trays, the blade trays secured to the one or more of the blade holders via tensioning screws threadingly engaged to the blade trays, rotation of the tensioning screws relative to the blade trays translate into a movement of the blade trays relative to the one or more of the two blade holders thereby varying the tension in the blades.

In some embodiments, each of the blade trays defines a slot sized for receiving a respective one of the blades.

In some embodiments, each of the blade holders define slots interspaced between teeth, each of the blade trays received within a respective one of the slots.

In some embodiments, the blades are locked to the blade trays via pins received through registering apertures defined through both of the blades and the blade trays.

In some embodiments, a handle is secured to the frame, the handle sized to be engaged by a hand of a user for moving the frame between the open position and the closed position.

In some embodiments, the cutting surface defines grooves, the blades at least partially received in the grooves in the closed position of the frame.

### BRIEF DESCRIPTION OF THE DRAWINGS

Reference is now made to the accompanying figures in which:

FIG. 1 is a three dimensional view of a tissue cutting device in accordance with one embodiment, the tissue cutting device shown in a closed position;

FIG. 2 is a three dimensional view of the tissue cutting device of FIG. 1 shown in an open position for receiving a tissue;

FIG. 3 is a three dimensional exploded view of a cutting assembly in accordance with one embodiment for the tissue cutting device of FIG. 2;

FIG. 4 is a three dimensional view of a blade holder for the cutting assembly of FIG. 3;

FIG. 5 is a three dimensional view of a blade tray for the cutting assembly of FIG. 3; and

FIG. 6 is a three dimensional exploded view of a base in accordance with one embodiment for the tissue cutting device of FIG. 1.

### DETAILED DESCRIPTION

Precisely cutting the tissue is of utmost importance to be able to carry an effective analysis afterwards. Currently, tissues are cut manually and several issues arise from this process. Namely, the slices cut manually have an uneven thickness, from one slice to the other and/or within the same slice. This lack of precision in cutting the slices may lead to missing an important lesion in the tissue. Cutting manually requires a technician to hold the tissue steady, which put the technician at risk of cutting himself. The blades have to be replaced frequently either because they go blunt or to avoid contaminating another tissue with a worn blade. In the later case, it becomes very difficult to differentiate the contaminant from the healthy tissue.

Moreover, cutting a biological tissue is challenging as biological tissues are complex structures made up of various cells, extracellular matrix, and other components. Depending on the tissue, they can have varying degrees of hardness, elasticity, and toughness, which can make them quite difficult to cut. Also, most biological tissues have a high water content, which can make them slippery and difficult to hold and cut. This is particularly true for soft tissues like brain or liver. Tissues can vary significantly in their composition, density, and other physical properties. For example, muscle tissue can have variable amounts of connective tissue, which can affect its resistance to cutting.

In the present disclosure, each of the expressions “extend(s) radially”, “extend(s) vertically”, “extend(s) longitudinally”, “extend(s) transversally”, “extend(s) axially”, and “extend(s) circumferentially” are meant to imply that a direction includes a respective one of a component in a radial, vertical, longitudinal, transversal, axial, and circumferential direction. For instance, “extending vertically” implies that a direction has a component along a vertical axis, but does not necessarily mean that it extends in a direction being solely vertical. In the present disclosure, the expression “tissue” refers to biological tissue (e.g., organs, skin, muscles, etc).

In some cases, very high tension/pressure/torque is required to cut the tissues evenly and accurately, with high precision. There is a high risk of deformation occurring at the shaft holding the blades and at the blades themselves, which is detrimental to the targeted accuracy. This shaft tends to curve due to the high pressure applied, causing disparity for the tension applied on the tissue from the blades. Another challenge is the capability to obtain an equal distribution of the high pressure required on the various blades.

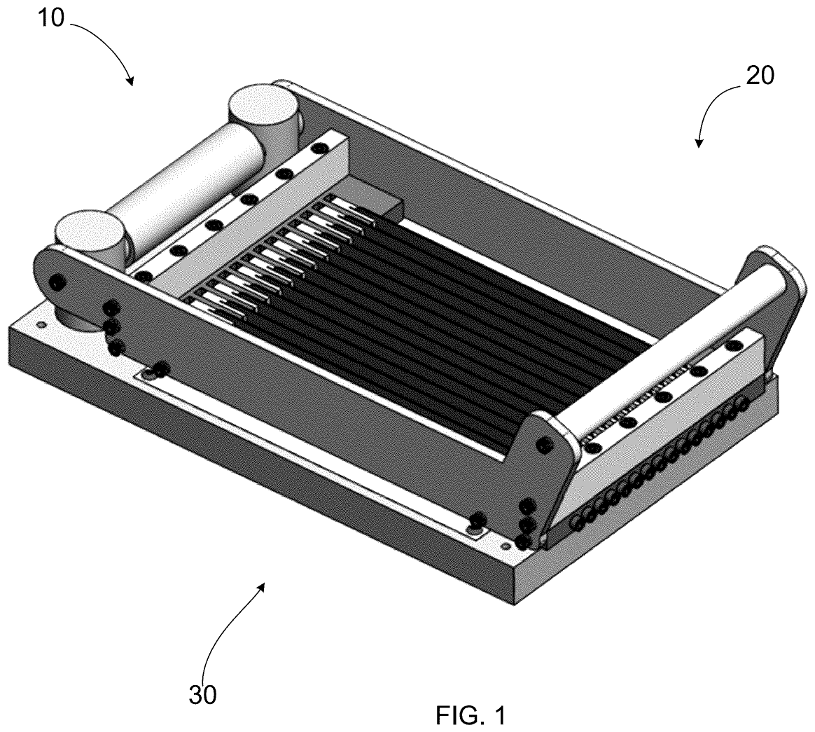

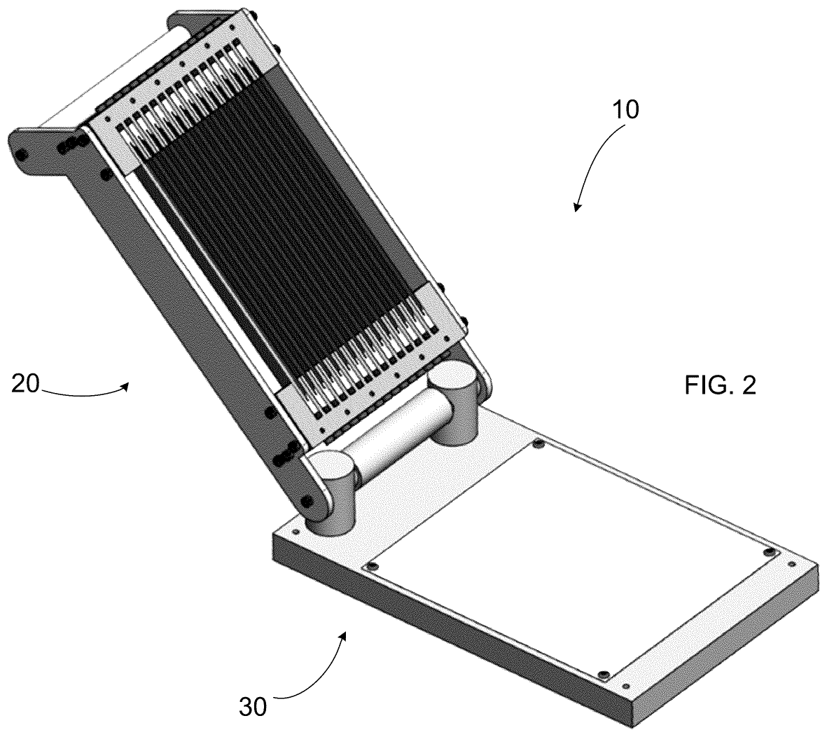

Referring to FIGS. 1-2, a tissue cutting device, also referred to as a slicing device, is shown at 10. The cutting device 10 may at least partially address the above-noted drawbacks. The cutting device 10 includes a cutting assembly 20 pivotably connected to a base 30. The cutting device 10 is shown in a closed position in FIG. 1 in which the cutting assembly 20 abuts the base 30 and is shown in an open position in FIG. 2 in which the cutting assembly 20 is distanced from the base 30 to receive a tissue to be sliced between the cutting assembly 20 and the base 30.

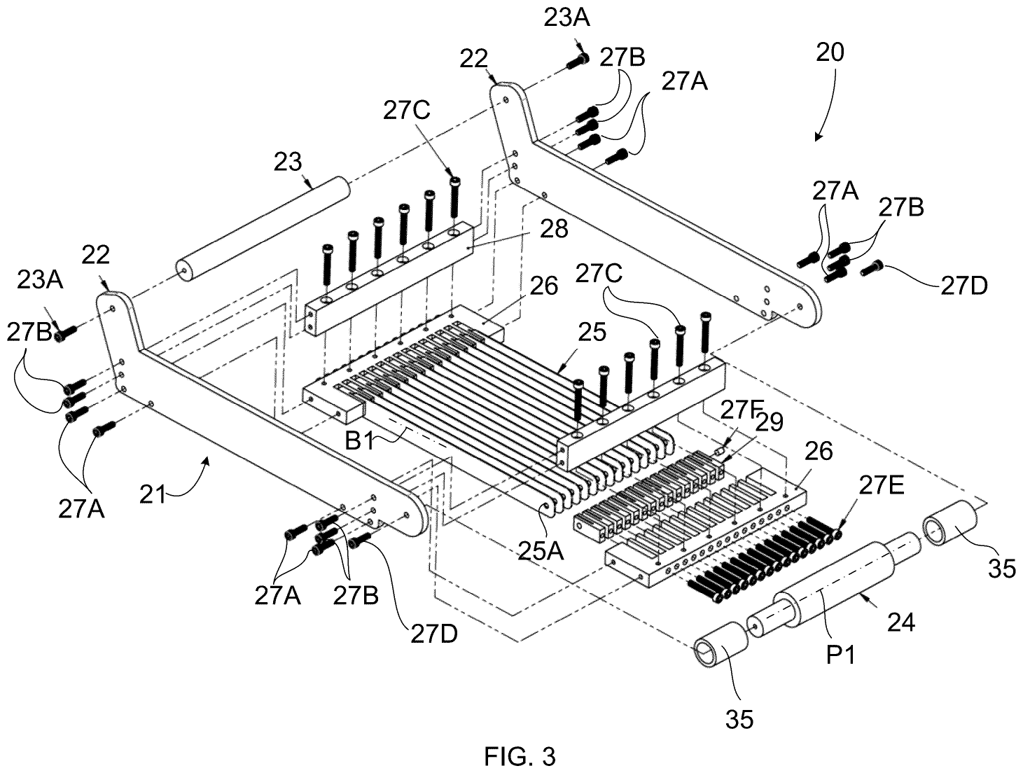

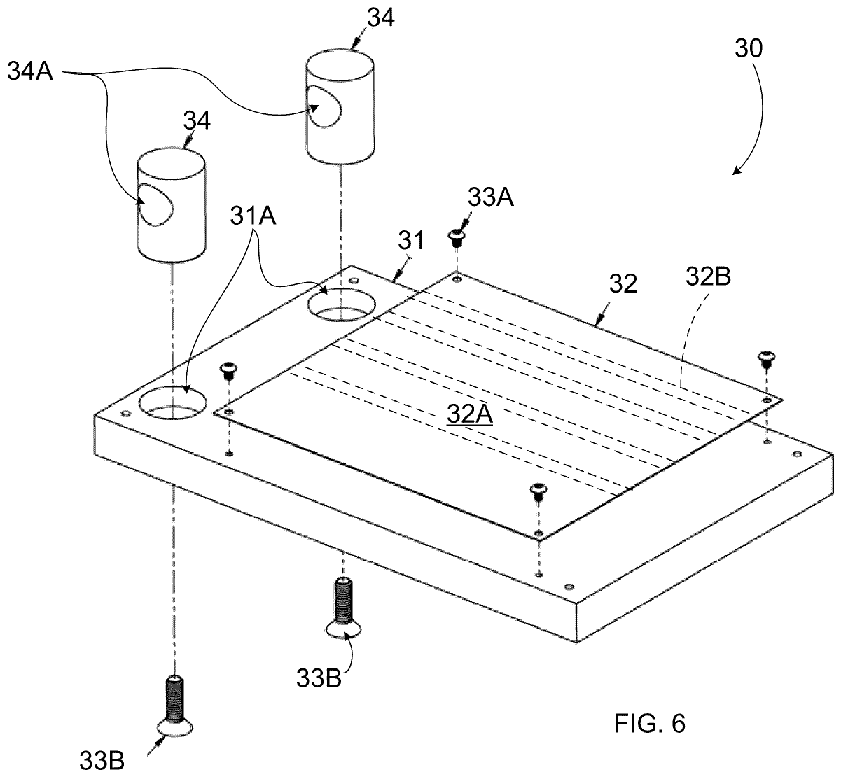

Referring to FIG. 3, the cutting assembly 20 is described in greater detail. The cutting assembly 20 includes a frame 21 having side supports 22 and a handle 23 spanning a distance defined between the side supports 22. The handle 23 is secured to the two side supports 22 via fasteners 23A. The handle 23 is configured to be engaged by a hand of a user for pivoting the cutting assembly 20 relative to the base 30 about a pivot axis P1 for cutting the tissue sample. A pivot 24 extends between the side supports 22, and is connected to the side supports 22, and is configured to be hingedly coupled to the base 30 as will be discussed below with reference to FIG. 6.

In the embodiment shown, the cutting assembly 20 holds a plurality of blades 25, which may be made of stainless steel or any other suitable medically-approved material. The blades 25 may be referred to as cutting knives. The blades 25 may have a length from about 7.5 inches to about 10 inches. The blades 25 may be spaced apart by about 10 mm, but this distance may be different in some embodiments. These blades 25 are able to sustain sufficient tension to be able to cut through any tissue (even hard and calcified tissue). In the embodiment shown, the cutting device 10 includes fifteen blades 25, but more or less is contemplated. Moreover, it is possible to use only a subset of the blades 25 by removing the other blades. This may be useful when thicker slices of tissue are required. The blades 25 are distributed axially along the pivot axis P1 and each extends along a blade axis B1 being transverse to the pivot axis P1. The blades 25 are supported by blade holders 26. More specifically, each ends of the blades 25 is secured to a respective one of the blade holders 26. The blade holders 26 are secured to the side supports 22 via first fasteners 27A. To add stiffness to the cutting assembly 20, transversal members 28 are used to connect the two side supports 22 together and are secured to the blade holders 26. The transversal members 28 are secured to both of the side supports 22 via second fasteners 27B. Each of the transversal members 28 is further secured to a respective one of the blade holders 26 via third fasteners 27C. It will be appreciated that, in one embodiment, the transversal members 28 may be omitted. In some embodiments, the transversal members 28 and the blade holders 26 may be two parts of a single monolithic body. The two side supports 22 are further secured to one another via the pivot 24, which is secured to the side supports 22 via fourth fasteners 27D. In the embodiment shown, the different fasteners are bolts, but any suitable fastening means may be used such as, rivets, screws, and so on. In some embodiments, the different parts of the cutting device may be welded to one another. In some cases, mechanical joinery may be used (e.g., tongue and groove, dovetail, etc).

By disposing two blade holders 26, two transversal members 28, and two sets of blade trays 29 at each ends of the blades 25, the cutting assembly 20 may have the required stiffness to ensure that the blades 25 do not bend or torque during use of the cutting device 10. The transversal members may have a rectangular cross section with the long side extending parallel to a direction of cutting. This may minimize the bending of the blade holders 26. This may ensure that the cuts are straight and even.

The cutting assembly 20 includes a tensioning mechanism configured for adjusting a tension in the blades 25. It may be desired to increase the tension in the blades 25 when cutting through hard tissue. Moreover, in some cases, it may be desired to have a non-uniform tension across the blades 25. In other words, some of the blades 25 may be required to have a greater tension than a remainder of the blades. The tensioning mechanism may allow to individually adjust the tension in each of the blades 25. In some cases, the different tensions may be required since consistencies of the tissues being cut may vary. Some tissues are soft and mushy and others are firm while some other are hard. A greater tension is used as the hardness of the tissue increases.

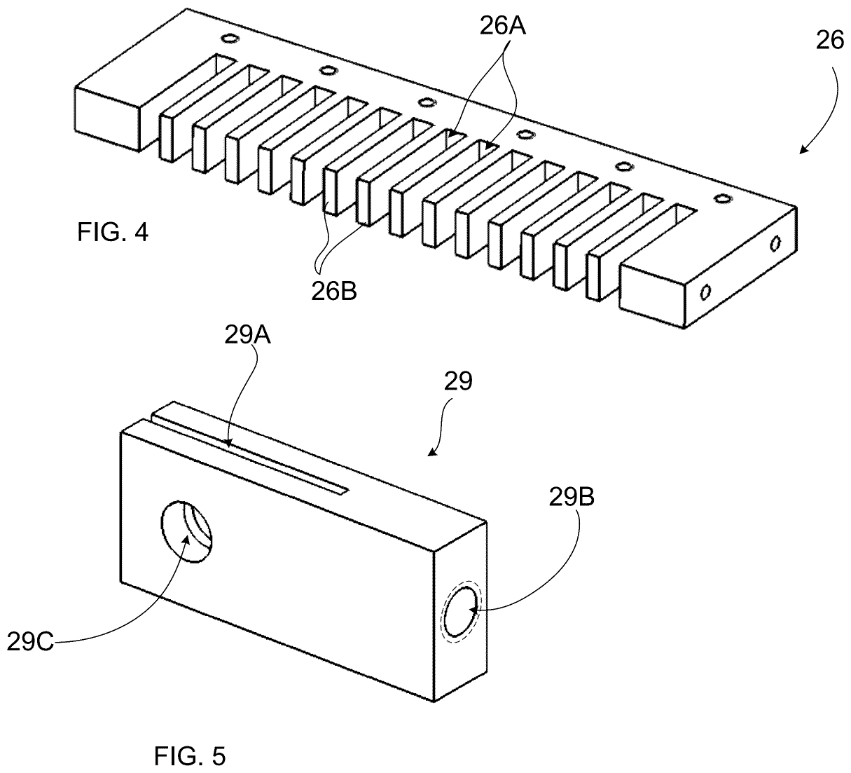

Referring to FIGS. 3-5, in this embodiment, the tensioning mechanism includes blade trays 29 securable to the blade holders 26 via tensioning screws 27E. In the embodiment shown, both ends of the blades 25 are engaged to a respective one of a plurality of blade trays 29. However, it will be appreciated that only one of the ends of the blades 25 may be engaged to a blade tray while the other end is fixedly secured to the blade holder 26. The blade trays 29 are sized to be received within correspondingly-shaped slots 26A defined by the blade holders 26. The slots 26A are defined between teeth 26B of the blade holders 26. The teeth 26B may be uniformly spaced apart from one another to ensure a consistent distance between the blades 25.

The blade trays 29 are sized to be slidably received between the slots 26A and themselves define a slot 29A sized for receiving one of the blades 25. The blade trays 29 are movable within the slots 26A of the blade holders 26 to adjust the tension in the blades 25. Each of the blade trays 29 further defines a threaded aperture 29B to be threadingly engaged by one of the tensioning screws 27E. Each of the blade trays 29 define a locking aperture 29C extending transversally to the threaded aperture 29B and extending across the slot 29A such as to extend through one of the blades 25. Locking pins 27F (FIG. 3) are sized to be received through the locking apertures 29C of the blade trays 29 and through apertures 25A of the blades 25 thereby locking the blades 25 to the blade holders 26 via the blade trays 29 and the tensioning screws 27E.

The blade trays 29 may overlap substantially an entire height of the blades 25. Therefore, the blade trays 29 may limit the blade 25 from bending or torquing about their blade axis B1. This may ensure that the blades 25 remain straight and do not deflect when they are required to cut through harder tissue. In other words, the blade trays 29 may prevent the blades 25 from wobbling during cutting. The blade trays 29 may further help in facilitating the replacement of the blades 25 individually.

To attach the blade 25, a user may slide ends of each of the blades 25 into the slots 29A of the blade trays 29 and insert the pins 27F into the locking apertures 29C to lock the blades 25 to the blade trays 29. Then, the user may insert each of the blade trays 29 into the slots 26A of the blade holders 26 and thread the tensioning screws 27E into the threaded apertures 29B of the blade trays 29. At which point, the user may increase tension in the blades 25 by torquing the tensioning screws 27E until a desired tension is achieved.

Any suitable means for varying the tension in the blades may be used. For instance, ends of the blades may be engaged to a cam member which may be rotatable by a user to vary the tension. In some embodiments, a lever may be engaged to the blades to vary the tension. In some embodiments, the two blade holders may be movable relative to the frame and an actuator may be used exert a force to move them away from each other to vary the tension in the blades. The actuator may be motorized or it may be a manual actuator, such as a screw.

Referring now to FIG. 6, the base 30 of the cutting device 10 is now described. The base 30 includes a base plate 31 configured to support the cutting assembly 20. The base plate 31 may rest on a working surface, such as a table. Anti-slipping pads may be provided below the base plate 31 to limit movements of the base 30 relative to the working surface during use of the cutting device 10. The base 30 further includes a cutting board 32 secured to the base plate 31 via fasteners 33A. The cutting board 32 may be made of plastic or any other material suitable for cutting tissue. The material of the cutting board 32 is also selected to minimize wear on the blades 25. The cutting board 32 is removably secured to the base plate 31 to be replaced periodically.

The cutting board 32 defines a cutting surface 32A against which the tissue is cut. The cutting surface 32A is substantially flat. In the context of this disclosure, the expression “substantially flat” implies that the cutting surface 32A is devoid of grooves, but may include a texture. For instance, the cutting surface 32A may be rough to limit slippage of the tissue during the cutting procedure. In some embodiments, the cutting surface 32A may define grooves 32B in register with the blades 25. This may allow the blades 25 to pass through the tissue as they are received within the grooves.

The base 30 further includes posts 34 secured to the base plate 31 and protruding away therefrom. The posts 34 are each received within a correspondingly-shaped aperture 31A. The apertures 31A have an upper portion and a lower portion. The upper portion has a diameter matching that of the posts 34 and the lower portion has a diameter sized to receive fasteners 33B. The apertures 31A define shoulders against which the posts 34 abut. The posts 34 define threaded apertures to be threadingly engaged by the fasteners 33B. Hence, once the posts 34 are inserted in the upper portion of the apertures 31A of the base plate 31, the fasteners 33B may be inserted through the lower portions of the apertures 31A and threadingly engaged to the threaded apertures of the posts 34 to secure the posts 34 to the base plate 31. Any other ways of securing the posts 34 to the base plate 31 are contemplated. For instance, the posts 34 may be welded to the base plate 31. The posts 34 and the base plate 31 may be two parts of a single monolithic body. The posts 34 may define a threaded shank threadingly engaged to threads of the apertures 31A.

Referring to FIGS. 3 and 6, the posts 34 each define pivot-receiving apertures 34A sized to receive bearings 35, such as bushings, journal bearings, ball bearings, and so on. These bearings 35 are mounted to ends of the pivot 24 to permit a rolling engagement between the posts 34 and the pivot 24. In other words, the cutting assembly 20 is rollingly supported by the bearings 35 and the pivot 24.

The disclosed cutting device 10 may be capable of producing faster, thinner, cleaner, equally-cut slices in a much more accurate manner compared to existing techniques. The cutting device 10 disclosed herein may be more economical since it may reduce blade usage, may be much more accurate, and may provide pathologists with an evenly and thin cut tissue which ultimately may be beneficial for patients and pathologists.

It is noted that various connections are set forth between elements in the preceding description and in the drawings. It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities. The term “connected” or “coupled to” may therefore include both direct coupling (in which two elements that are coupled to each other contact each other) and indirect coupling (in which at least one additional element is located between the two elements).

It is further noted that various method or process steps for embodiments of the present disclosure are described in the preceding description and drawings. The description may present the method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the description should not be construed as a limitation.

Furthermore, no element, component, or method step in the present disclosure is intended to be dedicated to the public regardless of whether the element, component, or method step is explicitly recited in the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various aspects of the present disclosure have been disclosed, it will be apparent to those of ordinary skill in the art that many more embodiments and implementations are possible within the scope of the present disclosure. For example, the present disclosure as described herein includes several aspects and embodiments that include particular features. Although these particular features may be described individually, it is within the scope of the present disclosure that some or all of these features may be combined with any one of the aspects and remain within the scope of the present disclosure. References to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. The use of the indefinite article “a” as used herein with reference to a particular element is intended to encompass “one or more” such elements, and similarly the use of the definite article “the” in reference to a particular element is not intended to exclude the possibility that multiple of such elements may be present.

In the context of this disclosure, the expression “about” implies variations of plus or minus 10%.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. A biological tissue cutting device for slicing a biological tissue sample, comprising:
a base defining a cutting surface against which the biological tissue sample is laid on;
a cutting assembly having a frame pivotably mounted to the base, the frame pivotable relative to the base about a pivot axis, and blades secured to the frame, the frame being movable from an open position in which the blades is distanced from the cutting surface to a closed position in which the blades contact or are proximate to the cutting surface.

2. The biological tissue cutting device of claim 1, wherein the blades are individually removable from the cutting assembly.

3. The biological tissue cutting device of claim 1, comprising means for individually adjusting tensions in the blades.

4. The biological tissue cutting device of claim 1, wherein the cutting surface extends continuously along a width and a depth of the base.

5. The biological tissue cutting device of claim 4, wherein the cutting surface is flat.

6. The biological tissue cutting device of claim 5, wherein the base includes a base plate and a cutting board removably secured to the base plate, the cutting surface defined by the cutting board.

7. The biological tissue cutting device of claim 6, wherein the cutting assembly is pivotably mounted to the base plate.

8. The biological tissue cutting device of claim 1, wherein the cutting surface has a rough surface finish.

9. The biological tissue cutting device of claim 1, wherein the frame includes two side supports extending transversally to the pivot axis and two blade holders extending transversally to the two side supports, ends of the blades mounted to the two blade holders.

10. The biological tissue cutting device of claim 9, wherein the ends of the blades are mounted to the two blade holders via a tensioning mechanism configured for varying tensions in the blades.

11. The biological tissue cutting device of claim 10, wherein the tensioning mechanism include blade trays, the blades secured to one or more of two blade holders via the blade trays, the blade trays secured to the one or more of the blade holders via tensioning screws threadingly engaged to the blade trays, rotation of the tensioning screws relative to the blade trays translate into a movement of the blade trays relative to the one or more of the two blade holders thereby varying the tension in the blades.

12. The biological tissue cutting device of claim 11, wherein each of the blade trays defines a slot sized for receiving a respective one of the blades.

13. The biological tissue cutting device of claim 11, wherein each of the blade holders define slots interspaced between teeth, each of the blade trays received within a respective one of the slots.

14. The biological tissue cutting device of claim 11, wherein the blades are locked to the blade trays via pins received through registering apertures defined through both of the blades and the blade trays.

15. The biological tissue cutting device of claim 1, comprising a handle secured to the frame, the handle sized to be engaged by a hand of a user for moving the frame between the open position and the closed position.

16. The biological tissue cutting device of claim 1, wherein the cutting surface defines grooves, the blades at least partially received in the grooves in the closed position of the frame.
